(19) United States
(12) Patent Application Publication
(10) Pub. No.: US 2005/0105997 A1
(43) Pub. Date: May 19, 2005

(54) Methods and apparatus for carriers suitable for use in high-speed/high-acceleration transport systems

(76) Inventors: Eric A. Englhardt, Palo Alto, CA (US); Michael R. Rice, Pleasanton, CA (US)

Correspondence Address: DUGAN & DUGAN, PC, 55 SOUTH BROADWAY, TARRYTOWN, NY, 10591, US

(21) Appl. No.: 10/934,641

(22) Filed: Sep. 4, 2004

Related U.S. Application Data
(60) Provisional application No. 60/502,049, filed on Sep. 11, 2003.

(51) Int. Cl. B65G 1/00

(52) U.S. Cl. 414/626

(57) ABSTRACT

A substrate carrier is counterbalanced so that the center of gravity of the carrier is aligned with the center of gravity of any substrates that the carrier may hold. In some embodiments, substrate supports disposed within the carrier are adapted to hold substrates such that the center of gravity of the substrates are aligned with the center of gravity of the carrier. A flange may be coupled to the carrier so as to provide a means to apply a net lifting or support force to the carrier that is aligned with the center of gravity of the carrier.

This application claims priority to U.S. Provisional Patent Application No. 60/502,049, filed Sep. 11, 2003, entitled “SUBSTRATE CARRIER FOR HIGH-SPEED/HIGH-ACCELERATION INTERSTATION TRANSPORT,” the content of which is hereby incorporated herein by reference in its entirety for all purposes.

### CROSS REFERENCE TO RELATED APPLICATIONS

The present application is related to the following commonly-assigned, co-pending U.S. Patent Applications, each of which is hereby incorporated herein by reference in its entirety for all purposes:

U.S. patent application Ser. No. 10/650,310, filed Aug. 28, 2003 and titled “System For Transporting Substrate Carriers” (Attorney Docket No. 6900);

U.S. patent application Ser. No. 10/650,312, filed Aug. 28, 2003 and titled “Method and Apparatus for Using Substrate Carrier Movement to Actuate Substrate Carrier Door Opening/Closing” (Attorney Docket No. 6976);

U.S. patent application Ser. No. 10/650,481, filed Aug. 28, 2003 and titled “Method and Apparatus for Unloading Substrate Carriers from Substrate Carrier Transport Systems” (Attorney Docket No. 7024);

U.S. patent application Ser. No. 10/650,479, filed Aug. 28, 2003 and titled “Method and Apparatus for Supplying Substrates to a Processing Tool” (Attorney Docket No. 7096);

U.S. Provisional Patent Application No. 60/407,452, filed Aug. 31, 2002 and titled “End Effector Having Mechanism For Reorienting A Wafer Carrier Between Vertical And Horizontal Orientations” (Attorney Docket No. 7097/L);

U.S. Provisional Patent Application No. 60/407,337, filed Aug. 31, 2002, and titled “Wafer Loading Station with Docking Grippers at Docking Stations” (Attorney Docket No. 7099/L);

U.S. patent application Ser. No. 10/650,311, filed Aug. 28, 2003 and titled “Substrate Carrier having Door Latching and Substrate Clamping Mechanism” (Attorney Docket No. 7156);

U.S. patent application Ser. No. 10/650,480, filed Aug. 28, 2003 and titled “Substrate Carrier Handler That Unloads Substrate Carriers Directly From a Moving Conveyor” (Attorney Docket No. 7676);

U.S. patent application Ser. No. 10/764,982, filed Jan. 26, 2004 and titled “Methods and Apparatus for Transporting Substrate Carriers” (Attorney Docket No. 7163);

U.S. patent application Ser. No. 10/764,820, filed Jan. 26, 2004, and titled “Overhead Transfer Flange and Support for Suspending Substrate Carrier” (Attorney Docket No. 8092);

U.S. Provisional Patent Application No. 60/443,115, filed Jan. 27, 2003, and titled “Apparatus and Method for Storing and Loading Wafer Carriers” (Attorney Docket No. 8202/L);

U.S. Provisional Patent Application No. 60/520,180, filed Nov. 13, 2003, and titled “Calibration of High Speed Loader to Substrate Transport System” (Docket No. 8158/L); and

U.S. Provisional Patent Application No. 60/520,035, filed Nov. 13, 2003, and titled “Apparatus and Method for Transporting Substrate Carriers Between Conveyors” (Docket No. 8195/L).

### FIELD OF THE INVENTION

The present invention relates to the transport of substrates, masks, reticules, etc. within a electronic device manufacturing facility. More specifically, the present invention relates to carriers for housing substrates during high-speed/high-acceleration interstation transport.

### BACKGROUND OF THE INVENTION

Different types of substrates (such as silicon wafers, polymer substrates, glass plates, etc.), masks, reticules, other devices, and other materials are commonly housed in sealable or open carriers while being transported in an electronic device manufacturing facility between processing stations (or from a storage location to a processing station). For example, substrates may be stored in containers or carriers known as Front Opening Unified Pods (hereinafter “FOUPs”), some of which are designed to retain twenty-five (25) substrates simultaneously. As used herein, the term substrate may refer to any type of substrate, mask, reticule, other device, and/or other material that may be transported within a carrier about an electronic device manufacturing facility.

While carriers containing substrates are moved about a manufacturing facility, care is taken to ensure that the substrates are protected from damage, e.g. due to shifting and/or expected/unexpected impact. Commonly, the same transport system and its associated carrier handlers will be called upon to transport and/or handle carriers containing relatively few substrates as well as carriers containing many substrates, e.g., depending on batch size and/or the throughput capacity of a particular processing station. Such differently-loaded carriers may exhibit different handling characteristics. This may complicate the task of safely transporting and handling the carriers.

A need exists for apparatus and methods for reducing the variation in handling characteristics of carriers being transported about a manufacturing facility.

### SUMMARY

In a first aspect of the invention, a carrier is counterbalanced so that the center of gravity of the carrier is aligned with the center of gravity of any substrates that the carrier may hold.

In a second aspect of the invention, a carrier is provided with substrate supports disposed within the carrier. The substrate supports are adapted to hold substrates such that the center of gravity of the substrates are aligned with the center of gravity of the carrier.

In a third aspect of the invention, a flange is coupled to a carrier so as to provide a means to apply a net lifting or support force to the carrier that is aligned with the center of gravity of the carrier.

In a fourth aspect of the invention, a flange that includes a conical member extending outwardly from the top of a carrier is provided to allow a human operator to hold the carrier without contacting portions of the flange intended to only couple to a cradle.

In a fifth aspect of the invention, a flange that includes a grip member attached to the underside of the flange along a trailing edge of the flange is provided to allow a human operator to hold the carrier without contacting portions of the flange intended to only couple to a cradle.

Other features and aspects of the present invention will become more fully apparent from the following detailed description, the appended claims and the accompanying drawings.

### BRIEF DESCRIPTION OF THE DRAWINGS

FIG. 1A is a side elevational view of an empty conventional carrier according to the prior art.

FIG. 1B is a side elevational view of the conventional carrier of FIG. 1A fully loaded with substrates.

FIG. 2A is a side elevational view of an example empty carrier according to some embodiments of the present invention.

FIG. 2B is a side elevational view of the example carrier of FIG. 2A fully loaded according to some embodiments of the present invention.

FIG. 3 is a side elevational view of an example, fully loaded, small lot carrier according to some embodiments of the present invention.

FIG. 4 is a perspective drawing illustrating a first example embodiment of a flange on a generic small lot carrier according to some embodiments of the present invention.

FIG. 5 is a close-up perspective drawing illustrating details of a flange depicted in FIG. 4 according to some embodiments of the present invention.

FIG. 6A is a cross-sectional view of details of a flange depicted in FIG. 4 taken along line 6A-6A in FIG. 5 according to some embodiments of the present invention.

FIG. 6B is a cross-sectional view of details of an alternate flange taken along a line similar to line 6A-6A in FIG. 5 according to some embodiments of the present invention.

FIG. 7 is a perspective drawing illustrating a second example embodiment of a flange on the small lot carrier of FIG. 3 according to some embodiments of the present invention.

FIG. 8 is a close-up perspective drawing illustrating details of a top view of a flange depicted in FIG. 7 according to some embodiments of the present invention.

FIG. 9 is a close-up perspective drawing illustrating details of a bottom view of a flange depicted in FIG. 7 according to some embodiments of the present invention.

FIG. 10 is a cross-sectional view of details of a flange depicted in FIG. 7 taken along line 10-10 in FIG. 9 according to some embodiments of the present invention.

FIG. 11 is a close-up perspective drawing illustrating details of an alternative flange according to some embodiments of the present invention.

FIG. 12 is a block diagram illustrating an overhead transport system according to some embodiments of the present invention.

### DETAILED DESCRIPTION

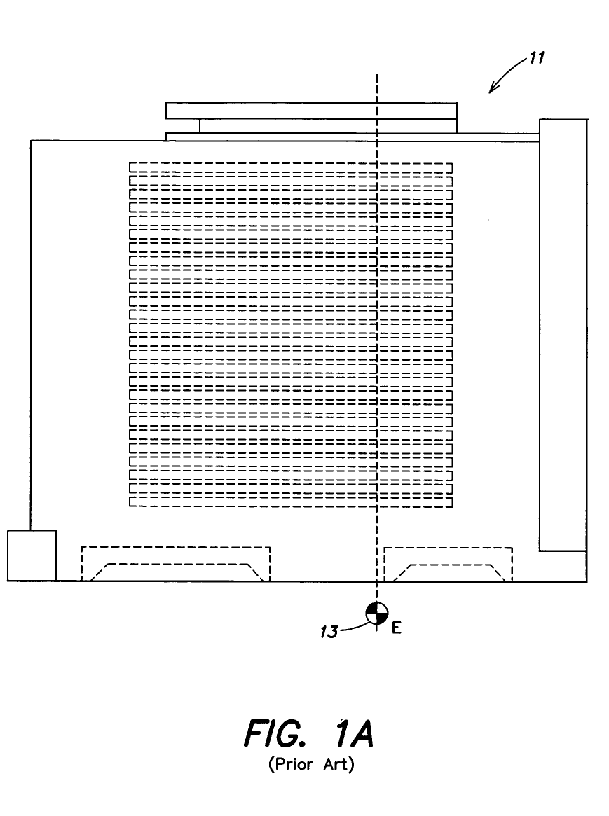

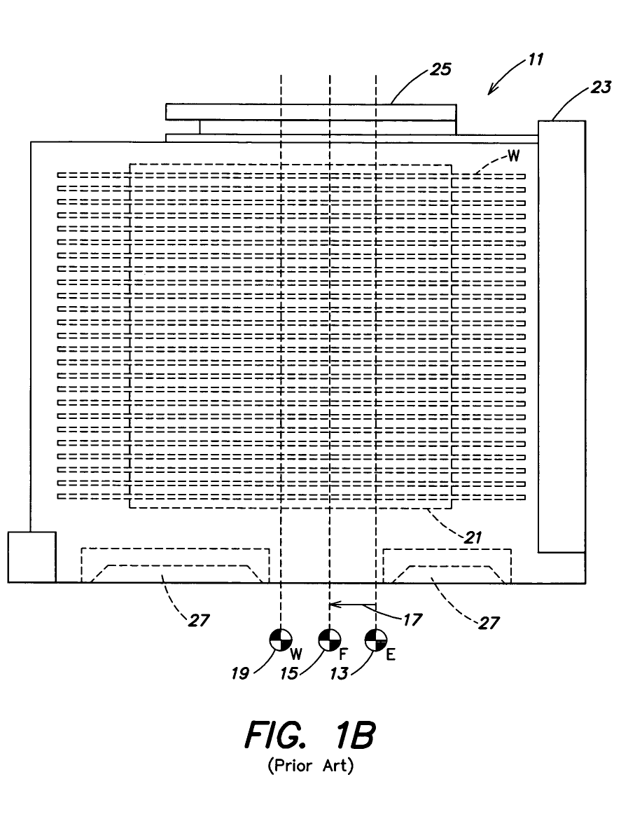

FIG. 1A illustrates a side elevational view of a conventional FOUP 11. When the conventional FOUP 11 is empty, it exhibits an “empty” center of gravity 13, i.e., the center of gravity (CG) of the FOUP 11 when no substrates are stored therein. FIG. 1B illustrates the same side elevational view of the conventional FOUP 11 of FIG. 1A, wherein the FOUP 11 is now loaded with a full batch of substrates W (shown in phantom) deposited for storage within the FOUP 11. As shown in FIG. 1B, the conventional FOUP 11 with the full batch of substrates W stored therein exhibits a “full” center of gravity 15 that occupies a different location than that of the empty center of gravity 13 of the FOUP 11, the effective center of gravity of the FOUP 11 having shifted away from the empty center of gravity 13 along a direction 17.

As further shown in FIG. 1B, each of the substrates W exhibits a “substrate” center of gravity 19. When the substrates W are stored in the conventional FOUP 11 together, the substrate center of gravity 19 of each stored substrate W will generally be substantially vertically aligned with that of every other stored substrate W, e.g., due to substrate supports 21 within the conventional FOUP 11 having been assembled in a vertically aligned fashion. The center of gravity of the FOUP 11 may gradually shift, e.g., from the empty center of gravity 13 to the full center of gravity 15 along the direction 17, as the substrates W are loaded (e.g., one by one) into the conventional FOUP 11 and as the percentage of the total weight of the FOUP/substrate assembly attributed to the weight of the substrates W increases. The conventional FOUP 11 may further comprise at least one vertically-oriented door 23, and/or other associated door mounting and receiving hardware. The door 23 and the associated hardware are conventionally laterally offset from the empty center of gravity 13 of the FOUP 11. This lateral offset may introduce a built-in imbalance which may be a primary cause of the above-described shifting effective center of gravity of the FOUP 11 when substrates are loaded into or removed from the FOUP 11.

Means for transporting carriers about a manufacturing facility include interstation transport systems such as overhead transport (hereinafter “OHT”) systems, which may include carrier supports or cradles adapted to engage a carrier via an interface flange 25 (see FIG. 1B) disposed on or near a top surface of the carrier. Means for depositing and/or removing carriers from OHTs include carrier handlers, which may include end effectors having kinematic features adapted to engage a carrier via corresponding kinematic features 27 (shown in phantom in FIG. 1B) disposed on or near a bottom surface of the carrier.

Well-balanced support for a carrier during such transporting, depositing, or removing is desirable. For example, if a net support force (e.g., if multiple points of contact for vertical support are used, the net support force may represent a resolution of those points of contact to a single force equivalent to the weight of the assembly, oriented vertically upward, and acting on a hypothetical single point) provided by the above-described transporting, depositing or removing means is substantially vertically aligned with the center of gravity of the assembly comprising the carrier and the substrates it contains, then the support may be considered well-balanced.

Recent developments in transportation and handling of carriers include increasing both interstation transport velocities and the attendant accelerations to levels not previously attempted in a electronic device fabrication facility (e.g., positively accelerating carriers to match high interstation transport system velocities prior to depositing the carriers on the interstation transport system and/or negatively accelerating such carriers at or near a processing station after removing the carriers from the interstation transport system). One such transport system is described in commonly assigned copending U.S. patent application Ser. No. 10/650,480, filed Aug. 28, 2003, the entire disclosure of which was incorporated by reference above.

The present inventors have observed that the above-described imbalance and difference in center of gravities between fully loaded, empty, and/or partially loaded carriers, which may be inherent in conventional FOUPs 11, may represent an increasingly large obstacle to providing well-balanced support for carriers in high-speed, high-acceleration interstation transport applications such as that described in the above referenced application. For example, when two conventional FOUPs 11 are loaded with different quantities of substrates W (e.g., selected from a range of zero to twenty-five substrates), the FOUPS 11 may be expected to exhibit effective centers of gravity that fall at different points along a line coinciding with direction 17 (FIG. 1B) and passing through and including both the empty center of gravity 13 and the full center of gravity 15. As such, though the two FOUPs 11 may employ identical external mechanical features such as flange 25 and/or kinematic features 27 that permit transport and manipulation of either or both FOUPs 11 by the same equipment, the differing internal contents and arrangements of the two FOUPs 11 may represent different weights resolving to different effective centers of gravity for each FOUP 11.

Such differing center of gravities may react differently to identical applications of a net support force. For example, if a portion of the transporting and/or handling system (e.g., a carrier support of an OHT system or an end effector of a carrier handler) is designed to apply a net support force at a hypothetical X-Y location which would be substantially aligned with the effective center of gravity of a fully-stocked FOUP 11, the same net support force might fail to provide adequately balanced support when applied to support a half-full or nearly empty FOUP 11 since a half-full FOUP's effective center of gravity is not aligned with the net support force.

In accordance with the present invention, a carrier is provided which, when empty, may include a center of gravity that is substantially vertically aligned with a center of gravity of substrates loaded into the carrier. This provides a constant X-Y position of the center of gravity for the carrier regardless of whether the carrier is empty, partially loaded, or fully loaded. As such, the problems of providing well-balanced support to carriers containing different numbers of substrates, and/or accommodating high-speed/high acceleration movements of the carriers during interstation transportation/transfer, such as those described above, may be reduced and/or eliminated. For example, an inventive carrier having a balanced center of gravity as described herein might be used to safely store substrates during transportation of the carrier between processing stations via a high-speed OHT system such as is described in U.S. patent application Ser. No. 10/764,982, entitled “Methods and Apparatus for Transporting Substrate Carriers,” filed Jan. 26, 2004, the entire disclosure of which is incorporated herein by this reference. As well, such a carrier might be similarly employed during depositing of the carrier on, or removal of the carrier from, the system of U.S. patent application Ser. No. 10/764,982 by a high-speed carrier handler such as is described in commonly assigned U.S. patent application Ser. No. 10/650,480, entitled “High-Speed Wafer Carrier Handler,” mentioned above.

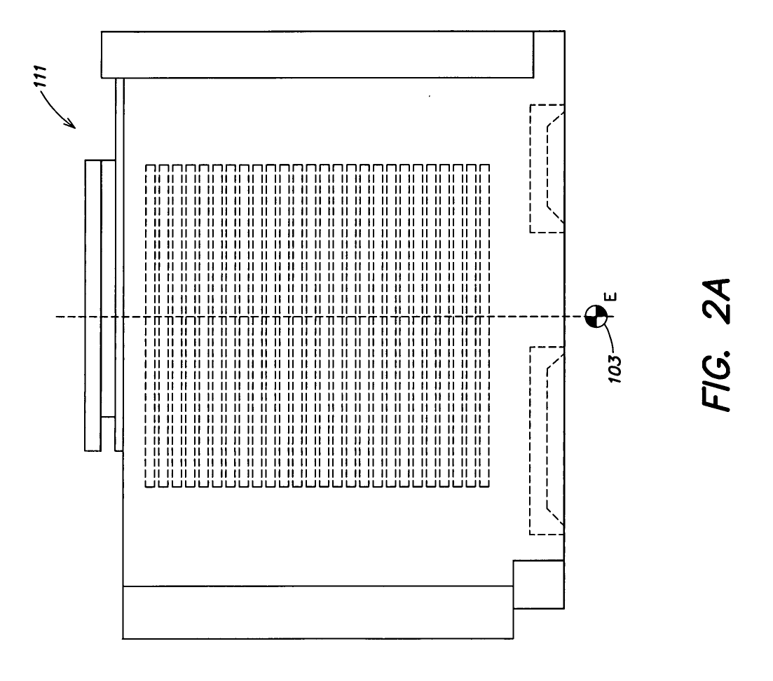

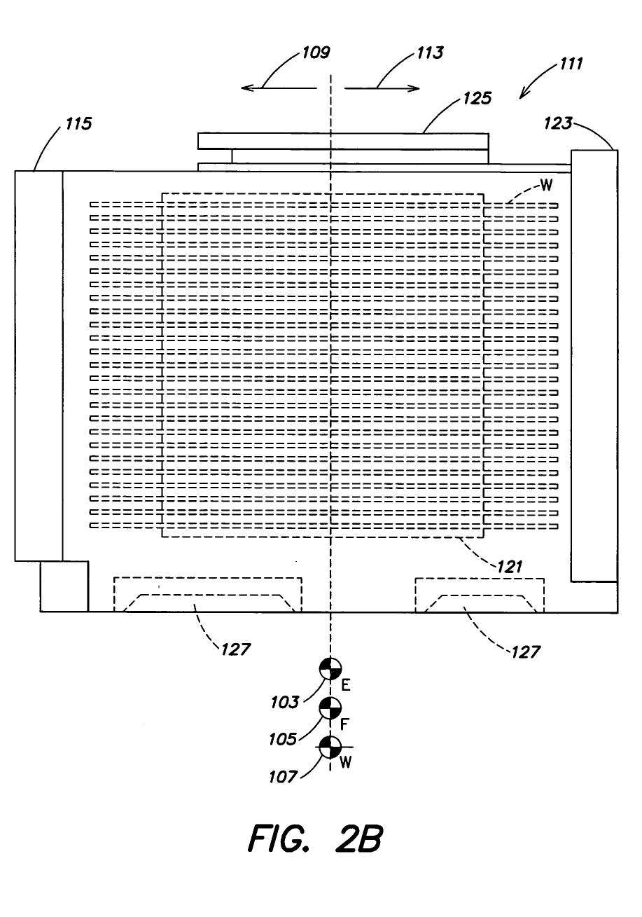

FIG. 2A is a side elevational view of an example inventive carrier or FOUP 111 that includes a center of gravity that may be vertically aligned with substrates stored therein, and/or with a net support force, in other words, well balanced. When empty, the inventive FOUP 111 exhibits an “empty” center of gravity 103. However, in contrast to the conventional FOUP 11 of FIGS. 1A and 1B, and as is shown with reference to the side elevational view of FIG. 2B, as the inventive FOUP 111 is filled with substrates W (shown in phantom), the center of gravity of the assembly (i.e., inventive FOUP 111 plus substrates W) does not move or shift. As such, when filled with substrates W as illustrated in FIG. 2B, the inventive FOUP 111 may exhibit a “full” center of gravity 105 that occupies the same position (e.g., left-to-right, or laterally, relative to the inventive FOUP 111) as the empty center of gravity 103. Each of the substrates W exhibits a “substrate” center of gravity 107 that may be aligned with that of every other substrate due to the position of the substrate holders 121, as may also be true in the conventional FOUP 11 of FIGS. 1A and 1B, but in accordance with the present invention, the substrate center of gravity 107 is also aligned with both the empty center of gravity 103 and the full center of gravity 105 of the FOUP 101. The FOUP 111 is thereby stable and/or balanced.

Carriers in accordance with the present invention may achieve this balance in any number of ways. For example, and as exemplified in the example FOUP 111 of FIGS. 2A and 2B, a FOUP 111 may include one or more counterbalancing masses disposed on a first side 109 of the empty center of gravity 103 of the FOUP 111 to compensate for the presence of one or more masses disposed on a second side 113 of the empty center of gravity 103 of the FOUP 111, such as for example, a door 123 and/or any mounting, guiding, and/or opening features of the door 123. As shown in FIG. 2B, a single balancing mass 115 may be coupled to a side wall of the inventive FOUP 111, (e.g., via appropriate epoxy, screws, bolts, other fasteners or fastening means, etc.) so as to provide such balancing. Those of ordinary skill in the art will recognize that multiple balancing masses and/or different density carrier/counterbalance materials may be used, and that they need not necessarily be restricted to any one particular location on the FOUP 111 (e.g., balancing masses may be located on a top or a bottom of the FOUP 111 and/or different density materials maybe used for all or a portion of the FOUP 111).

More broadly, carriers designed in accordance with the present invention may comprise a structure or geometry which distributes mass in other ways (e.g., not necessarily by the use of one or more specific counterweights) so as to balance the weight of the door 123 or any other mass which tends to leave the carrier unbalanced. For example, in one or more embodiments, an inventive carrier may include an increased non-door side 109 weight by selective specification of increased and/or decreased wall thicknesses and/or heights, and/or structural materials having different densities, to achieve the desired result of aligning the center of gravities of the FOUP 111 and any number of loaded substrates W.

Additionally, in such embodiments and/or in other embodiments, the mass of the door 123 (and/or the carrier on the door side) may be decreased so as to reduce and/or eliminate any need to increase the overall weight of the inventive carrier as compared to conventional FOUPs.

In some embodiments, instead of or in addition to counterbalancing the carrier by adding additional mass or removing mass from different sides of the carrier, a carrier may be balanced by locating the substrate supports such that the center of gravity of any (and all) substrates held by the substrate supports is aligned with the center of gravity of the carrier.

Further, given that carriers in accordance with the present invention provide a stable center of gravity, the mounting flange 125 (see FIG. 2B) and/or the kinematic mounting features 127 (see FIG. 2B) of an inventive carrier may be positioned, constructed, and/or designed so as to more closely align, and/or substantially align, a net support force applied to the FOUP 111 with the center of gravity of the inventive carrier. For example, if a carrier support of a high-speed OHT system were utilized to transport the inventive FOUP 111 via the mounting flange 125, an end effector of a high-speed carrier handler is utilized to engage the kinematic mounting features 127 of the inventive FOUP 111 so as to participate in high-speed FOUP exchanges with the overhead transfer system, the configurations and/or the lateral positions of the mounting flange 125 and the kinematic mounting features 127 may provide substantial alignment between net support forces and carrier center of gravity throughout all phases of interstation transport.

In some embodiments of a carrier in accordance with the present invention, a multi-substrate capacity greater than or less than twenty-five substrates may be provided. For example, single substrate capacity carriers and/or small lot size capacity carriers may be employed in some embodiments of the present invention.

As used herein, the term “small lot size” carrier or “small lot” carrier may refer to a carrier that is adapted to hold significantly fewer substrates than a conventional “large lot size” carrier which typically holds thirteen or twenty-five substrates. As an example, in some embodiments, a small lot size carrier is adapted to hold five or less substrates. Other small lot size carriers may be employed (e.g., small lot size carriers that hold one, two, three, four or more than five substrates, but significantly less than that of a large lot size carrier). In general, each small lot size carrier may hold too few substrates for human transport of carriers to be viable within a semiconductor device manufacturing facility.

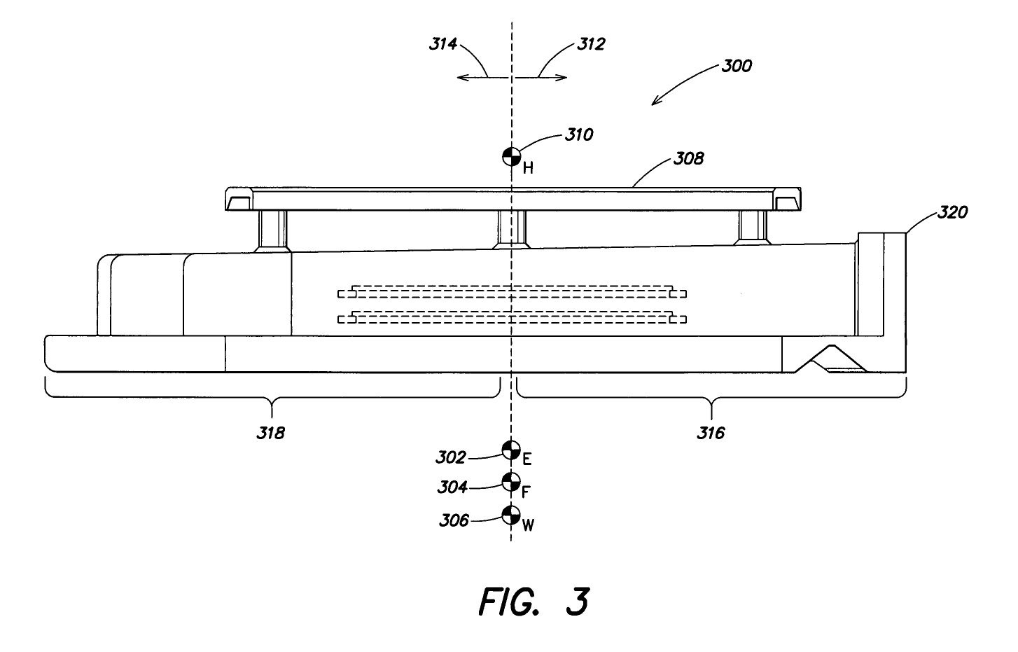

Turning to FIG. 3, an example embodiment of a small lot carrier 300 is depicted. Note that as with the FOUP 111 of FIG. 2A, the carrier 300 is balanced in that the center of gravity of the carrier 300 when empty (E) 302, the center of gravity of the carrier 300 when full (F) 304, and the center of gravity of the substrates (W) 306 are all aligned vertically such that a net supporting force applied via a flange 308 (and resolved to a hypothetical single point (H) 310) is able to lift the carrier 300 without generating any twisting moment, no matter how many substrates are in the carrier 300.

Note that the embodiment depicted in FIG. 3 does not include a plate or separate counterweight but instead uses a geometry and/or materials selection to achieve balance between the door side 312 and the non-door side 314 of the center of gravity. Note also that the door side 312 of the carrier 300 has a smaller length dimension 316 than the length dimension 318 of the non-door side 314 of the carrier 300. Thus, the geometric center of the carrier 300 is in a different position than the center of gravity 302 of the carrier 300. In some embodiments, the additional length (e.g., mass) on the non-door side 314 may balance that additional mass on the door side 312 that results from the door 320, door frame, guides, hinges, seals, etc.

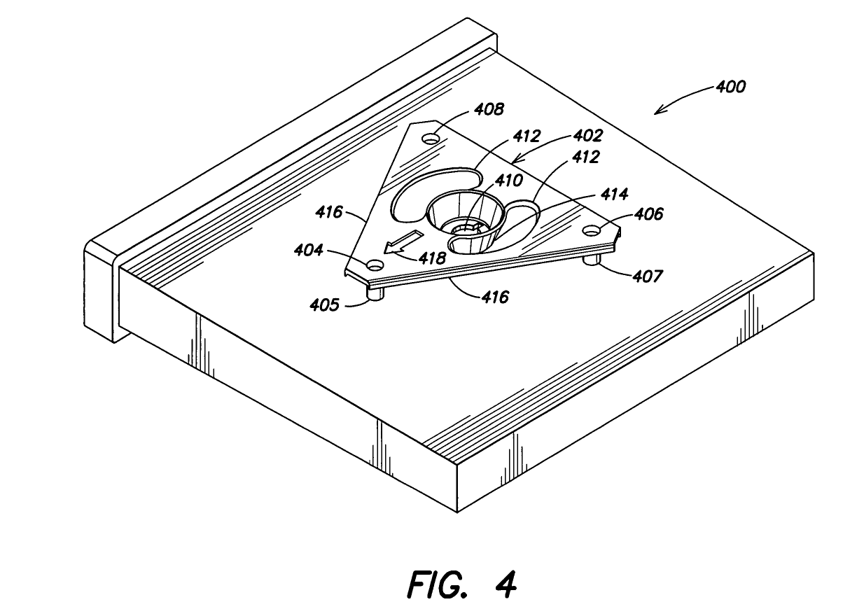

Turning to FIG. 4, a perspective illustration depicting an example of a balanced small lot carrier 400 including a delta-shaped flange 402 is provided. Note that in this example, the flange 402 may be attached to the carrier 400 at four distinct points 404, 406, 408, 410 to provide a rigid connection between the flange 402 and the carrier 400. In this example, the attachment points include three fastener holes (and boss locations) 404, 406, 408, each one located in a different corner of the flange 402, and a center lock coupling 410 in the center of the flange 402. Note that bosses 405, 407 may be attached to the flange 402 or to the carrier 400. Note that a third boss (not visible in FIG. 4) may be located under fastener hole 408. Other numbers and/or types of fasteners may be used.

In some embodiments, a spacer may simply be inserted between the flange 402 and the carrier 400 when the flange 402 is attached to the carrier 400 with appropriate fasteners (e.g. bolts, screws, adhesive, etc.). In some embodiments, the use of bosses 405, 407 and/or spacers allow the flange 402 to be offset from the carrier 400 so that a cradle (not pictured) of, e.g., an OHT system may pick-up the assembly by inserting contact points of the cradle under the leading edges 416 of the flange 402, between the flange 402 and the carrier 400. Note also that, in some embodiments, the carrier 400 may have an overall tapered shape for manufacturing reasons. For example, the carrier 400 may be designed to be more easily removed from a mold. In some embodiments where the carrier 400 does not include an outer surface that is parallel with the planes of substrates held within the carrier, different length bosses 405, 407 and/or varying spacers may be employed to align the flange 402 to be parallel with the planes of substrates held within the carrier. This alignment may allow the substrates to remain at a known reference pitch (e.g., zero degrees) at all times.

In some embodiments, the flange 402 may include cut-outs 412 to allow a human operator to easily grip a conical (or otherwise shaped) member 414 in the center of the flange 402. Note that the cut-outs 412 may include rounded-over edges to avoid having sharp edges that may otherwise abrade or cut operator gloves. These cut-outs 412 and conical member 414 may allow convenient handling of the carrier 400 without having to contact potentially sharp edges 416 of the flange 402 which may be designed for machine engagement of the flange 402 by a cradle (not pictured) in an OHT system (as described, for example, in U.S. patent application Ser. No. 10/764,820, entitled “Overhead Transfer Flange And Support For Suspending Substrate Carrier” incorporated by reference above). This may help reduce the possibility of clean room contamination via particle generation by reducing the chance that an operator abrades or cuts his gloves on potentially sharp edges 416.

Note that in some embodiments, the flange 402 may also include a indication of an orientation or direction of travel in an OHT system. This may be in the form of, for example, an arrow 418 or other indicia printed, embossed, engraved, or otherwise included on the flange 402.

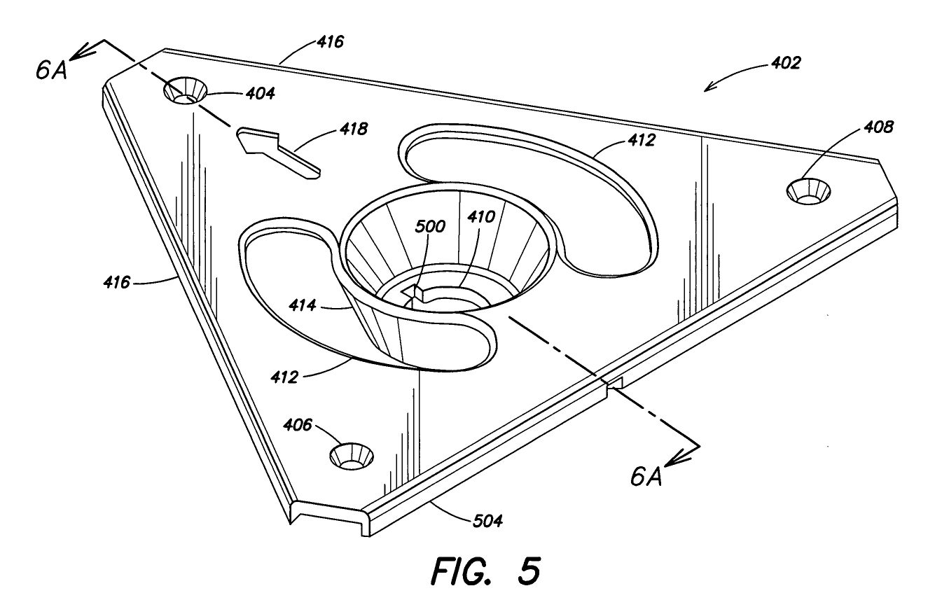

Turning to FIG. 5, a close-up perspective illustration of a flange 402 in a rotated position is provided. Many of the same features identified in FIG. 4 are also visible in FIG. 5 and thus, the same reference numerals are used. As explained above, the flange 402 may be attached to a carrier at four distinct points 404, 406, 408, 410 to provide a rigid connection between the flange 402 and the carrier. The attachment points may include three fastener holes (and boss locations) 404, 406, 408, each one located in a different corner of the flange 402, and a center lock coupling 410 in the center of the flange 402. The illustration in FIG. 5 more clearly depicts that the center lock coupling 410 may include opposing notches 500 (only one visible) to receive “twist-lock” keys (not pictured) that may protrude from the top surface of the carrier.

As indicated above, the flange 402 may include cut-outs 412 to allow a human operator to easily grip a conical or otherwise shaped member 414 in the center of the flange 402. These cut-outs 412 may allow convenient handling of the carrier 400 without having to contact potentially sharp edges 416 of the flange 402. The flange 402 may also include an arrow or other indicia 418 to indicate an orientation of the carrier.

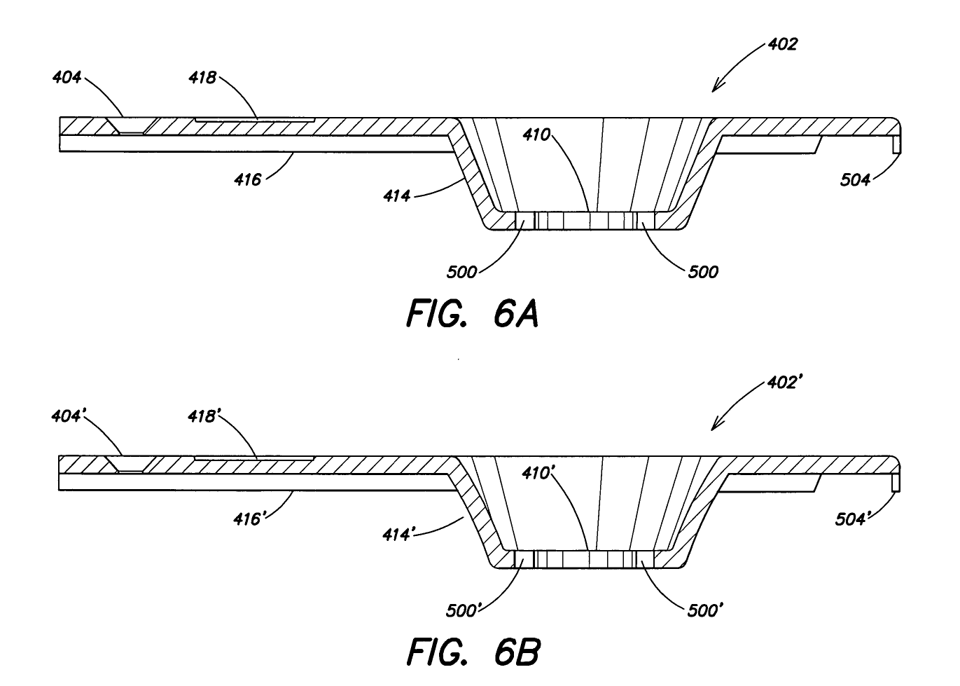

Turning to FIG. 6A, a cross-sectional view of the flange 402 of FIGS. 4 and 5 is provided. Referring back to FIG. 5, the cross-section is taken along a line 6A-6A. Turning forward to FIG. 6A, the fastener hole 404 may include sloped sides to receive a recessable fastener (not pictured), such as a machine screw with a sloped head, and allow the fastener to hold the flange 402. A shallow depression is visible to the right of the fastener hole 404, this represents a side view of the arrow 418. The illustration in FIG. 6A more clearly depicts that the outwardly sloping sides of the conical member 414 provide a convenient grip point for an operator. FIG. 6A also more clearly depicts that the center lock coupling 410 includes two opposing notches 500 to receive twist-lock keys (not pictured) that protrude from a top surface of the carrier. Also visible in the illustration of FIG. 6A is an inside view of one of the leading edges 416 and a side view of the trailing edge 504.

FIG. 6B depicts an alternate embodiment of a flange 402′ from a cross-sectional perspective similar to that of FIG. 6A. Note that individual features of this embodiment (i.e., 404′, 410′, 416′, 418′, 500′, 504′) previously discussed above are identified using the corresponding reference numerals used in FIG. 6A but with a prime (′) mark added.

In the example embodiment of FIG. 6B, the conical member 414′ includes spherical shaped sides as opposed to the sloped sides of the conical member 414 of FIG. 6A. In some other embodiments, differently shaped sides may be used. For example, in some embodiments the conical member 414′ may further include indentations for an operator's individual fingers or a concentric ridge around the middle of the conical member 414′. In some embodiments, the conical member 414′ may additionally be coated, e.g., with an anti-slip texture to further improve the operator's ability to securely grip the flange 402′.

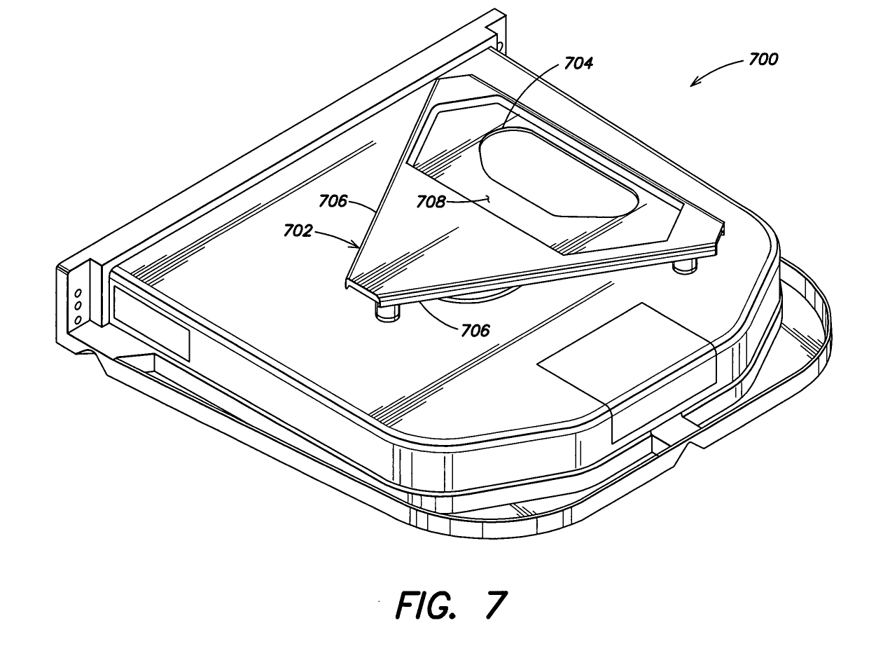

Turning to FIG. 7, a perspective illustration depicting a second example of a balanced small lot carrier 700 including an alternative delta-shaped flange 702 is provided. In some embodiments, the flange 702 may include a cut-out 704 to allow a human operator to easily grip the flange 702. This cut-out 704 may allow convenient handling of the carrier 700 without having to contact potentially sharp edges 706 of the flange 702 which may be designed for machine engagement of the flange 702 by a cradle (not pictured) in an OHT system. The flange 702 may additionally include a recessed area 708. The recessed area 708 may be shaped/sized so as to allow distribution of the weight of the flange 702 evenly on the carrier 700, e.g., so as to align the center of gravity of the flange 702 with the center of gravity of the carrier 700.

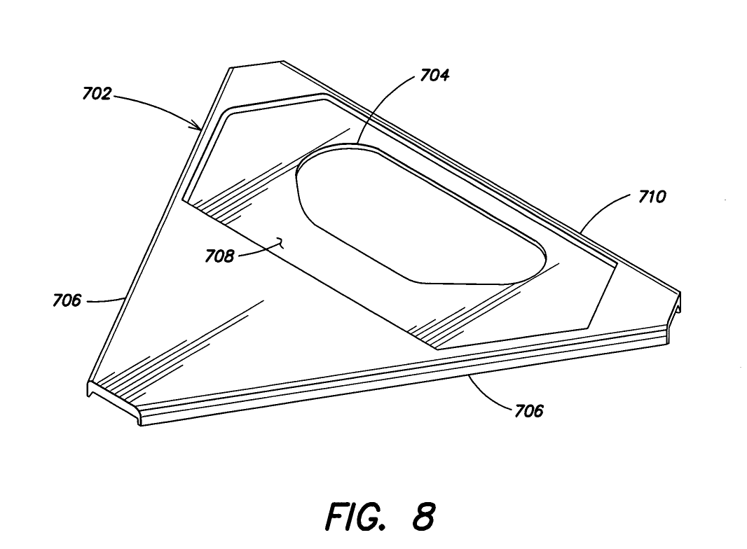

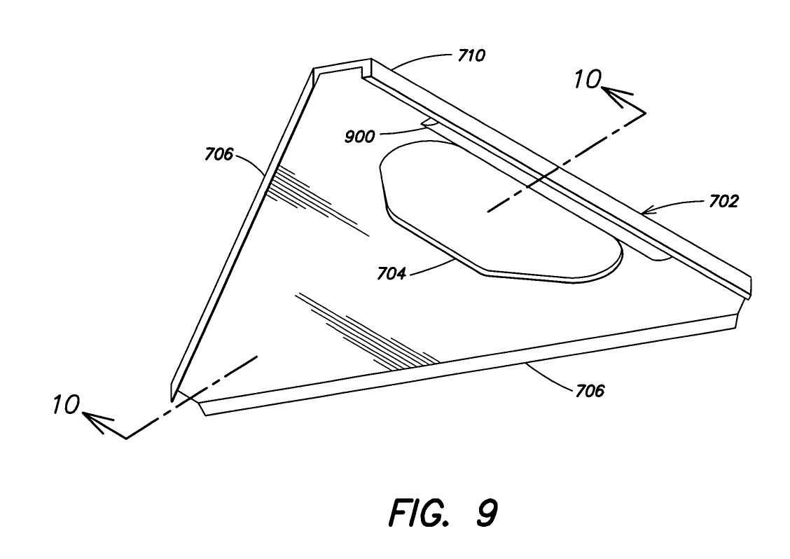

Turning to FIGS. 8 and 9, close-up perspective illustrations of the top and bottom of a flange 702 are provided. Many of the same features identified in FIG. 7 are also visible in FIGS. 8 and 9, and thus, the same reference numerals are used. The illustrations in FIGS. 8 and 9 show that the flange 702 may include cut-out 704 to allow a human operator to easily grip the flange 702. As indicated above, this cut-out 704 may allow convenient handling of a carrier without having to contact potentially sharp edges 706 of the flange 702. Also as indicated above, the flange 702 may additionally include a recessed area 708 for balancing the flange 702. The illustrations in FIGS. 8 and 9 show that the flange 702 may include a trailing edge 710.

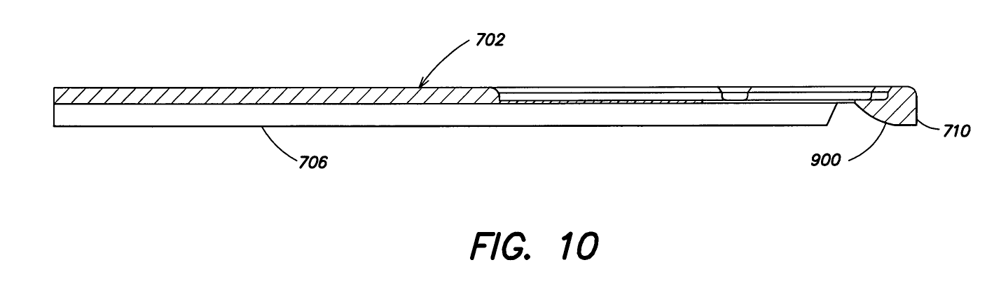

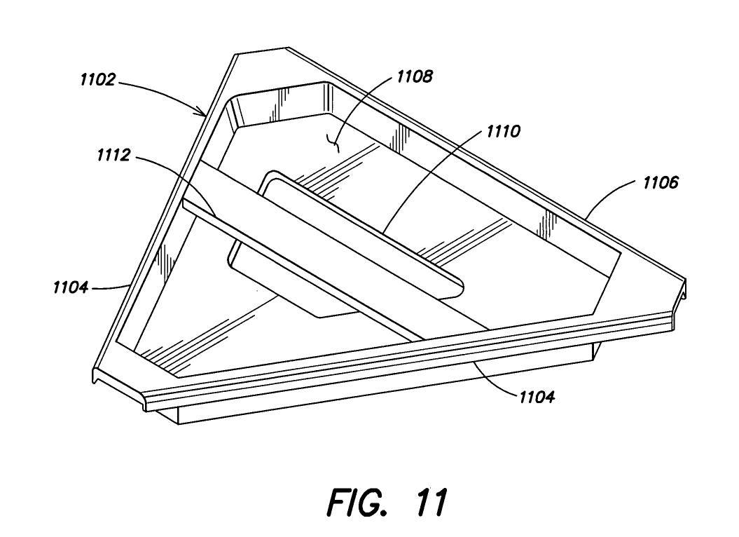

The illustrations in FIGS. 9 and 10 additionally provide a view of a grip member 900 that, in some embodiments, may be mounted on the underside of the flange 702 adjacent to, or integrated with, the trailing edge 710 to provide a smooth grip point for a human operator that will not abrade or cut an operator's gloves. The example grip member 900 shown in perspective in FIG. 9, and in cross-section in FIG. 10, is in a quarter bead shape. However, any suitable smooth shape may be used such as an ogee shape or a chamfered shape. This feature of the present invention may help reduce the possibility of clean room contamination due to particle generation as indicated above.

Turning to FIG. 11, a close-up perspective view of an alternative flange 1102 is provided. Flange 1102 includes leading edges 1104 and trailing edge 1106. Within the center of the flange 1102 is a depressed area 1108 that may mount flush to a top of a carrier (not pictured). Within the depressed area 1108, there may be a cut-out area 1110 wherein material may be removed to provide more clearance for a human operator's fingers to lift the carrier via a handle 1112. The handle 1112 may be disposed spanning between the leading edges 1104 of the flange 1102 or in any other suitable position. The handle 1112 may be rounded to provide a smooth gripping surface for an operator.

In some embodiments the flange 1102 may be detachably coupled to a carrier. In such embodiments, a clip attachment mechanism (not shown), or any other suitable removable fastening means, may be used. In some embodiments, a clip attachment mechanism may include one or more spring-loaded catches mounted on the carrier that each engage a notch, edge, and/or recess on the flange 1102 such that the flange 1102 is able to remain securely attached to the carrier even under forces due to high acceleration OHT systems, but may easily be detached by drawing back one or more of the catches.

The foregoing description discloses only exemplary embodiments of the invention. Modifications of the above disclosed apparatus and methods which fall within the scope of the invention will be readily apparent to those of ordinary skill in the art. For instance, other types of carriers besides FOUPs, such as bottom opening unified pods (BOUPs) and top opening unified pods (TOUPs), may be balanced according to the methods of the present invention to allow them to be employed in high speed/high acceleration OHT systems.

In some embodiments, substrate supports may be adjustable such that their position may be changeable to accommodate different size substrates. For example, a carrier designed to hold both 200 mm diameter wafers and 300 mm diameter wafers may include substrate supports that may each occupy one of two different positions. In other words, in some embodiments, substrate supports may each be locked in a first position for storing 200 mm wafers and, later, be put into a second position for storing 300 mm wafers.

In at least one embodiment, adjustable substrate supports may be used to balance batches of mixed types of substrates (e.g., align each and/or all of the substrates' center of gravities, and/or the collective substrates' center of gravity, with the carrier's center of gravity). For example, five different masks stored in a carrier may need to each be shifted different depths into a carrier using adjustable substrate supports to align their individual center of gravities with the carrier's, while twenty reticules stored in the same carrier may need to be shifted towards the carrier's door to align their collective center of gravity with the carrier's.

In some embodiments, a carrier may include a mass whose position may be adjusted to align the carrier's center of gravity with the net center of gravity of any substrates stored in the carrier. In some embodiments, an adjustable mass may be moved as needed to balance a carrier.

In other embodiments, a transport system may be operable to detect that a carrier is imbalanced and, in response, take steps to balance the carrier. For example, a transport system may include a sensor (e.g., a torque meter) on a cradle that engages a flange mounted on the carrier. If the sensor indicates that the carrier's net center of gravity is not aligned with the flange's net support force because there is a twisting force detected by the cradle's sensor, the transport system (e.g., via a robotic arm under the control of a processor) may add a counterbalancing mass to the carrier, adjust the position of adjustable substrate supports, adjust the position of an adjustable mass of the carrier, and/or indicate to an operator that the carrier needs to be balanced.

In one or more embodiments, a net support force substantially aligned with the center of gravity of a half-full carrier may be employed instead of aligning the substrate center of gravity with the empty carrier's center of gravity. In some embodiments, this approach might not be acceptable in the context of a high-speed, high-acceleration transport and transfer application. For example, during linear acceleration of a carrier in a direction perpendicular to the direction 17 of FIG. 1B (i.e., into the paper of FIG. 1B)), or during centripetal acceleration of a carrier during a constant-speed turn associated with a curved transport path tangentially aligned with the direction 17 of FIG. 1B (e.g., a curve defined by an OHT system or a carrier guide in which the acceleration is directed radially inward toward the center point of a curved path), the lateral urging forces applied by the accelerating device on the carrier may resolve to a net urging force that acts on the same laterally-offset hypothetical force-application point as does the net support force. Because the force of inertia acts in one direction on the effective center of gravity of the supported carrier assembly, and the net urging force acts in the opposite direction on the laterally-offset point, a horizontal moment or “twist” may rapidly arise which may further tend to increase in size with higher and higher acceleration levels.

Large horizontal moments such as just described may cause unwanted side-effects, undesirable stress on components of an OHT system, or may increase the magnitude of such side effects to unacceptably high levels. For instance, such a horizontal moment may grow sufficiently so as to unacceptably increase the risk of the conventional FOUP 11 abruptly twisting (e.g., via the above-described linear acceleration), and/or twisting beyond or less than the expected degree as defined by the curve of its transport path (e.g., via the above-described centripetal acceleration). Similarly, a risk may arise that one (or more) of the substrates W, that may not be specifically restrained as to rotation within the carrier (and subject to its own rotational inertia tending to resist rotation along with the conventional FOUP 11) may overcome static friction so as to slide and/or twist relative to its corresponding substrate support(s) 21.

Subjecting differently-loaded conventional FOUPs 11 to equivalent linear acceleration aligned with the direction 17 of FIG. 1B, or to equivalent centripetal acceleration during a constant-speed turn associated with a curved transport path passing perpendicular to the direction 17 of FIG. 1B (e.g., into the paper of FIG. 1B), may reveal that the two outwardly-identical conventional FOUPs 11 exhibit differing tendencies to tip (e.g., if supported from below) or swing (e.g., if supported from above) away from the direction of acceleration. This may be in part because the vertically-oriented moment formed by the horizontal offset between the net support force and the center of gravity of one of the carriers is larger than that of the other carrier. The carrier exhibiting the larger vertically-oriented moment will be less prone to tip or swing than the other carrier when the linear or centripetal acceleration is aligned with and applied in the same direction as the direction 17 of FIG. 1B, and more prone to tip or swing than the other carrier when the linear or centripetal acceleration is similarly aligned with but applied in a direction opposite to the direction 17 of FIG. 1B.

A system intended to accommodate all possible conventional FOUP 11 center of gravity positions may need to include oversized components in order to accommodate more tip-prone or twist-prone carrier loading arrangements. Also possible, and especially in high-speed, high-acceleration transport/transfer environments, is that the above-described offsets and resulting moments, and/or vibrations, and/or differential tipping or twisting tendencies, alone or in combination, may limit the capacities and speeds of such systems. The inventors of the present invention have determined that such limitations and drawbacks may be cost-effectively overcome by balancing the carrier as described herein.

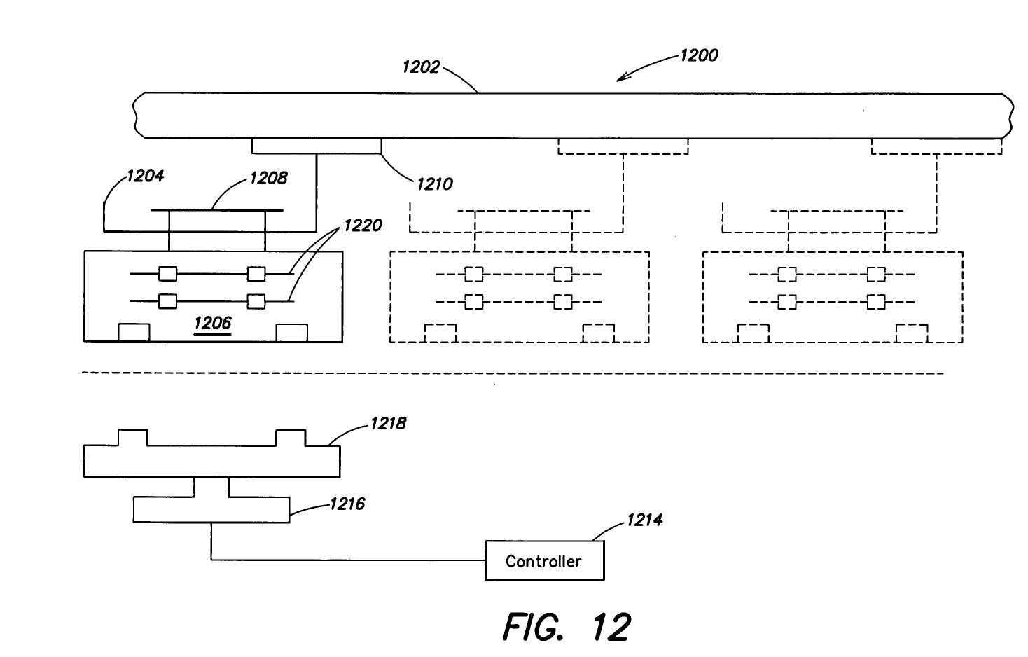

Turning to FIG. 12, an illustration depicting an OHT system 1200 according to the present invention is provided. As described in some of the applications incorporated by reference above, an OHT system 1200 may include a belt or band 1202 which may constantly circulate throughout an electronic device manufacturing facility. The band 1202 may include a number of cradles 1204 each designed to lift and support a carrier 1206 via a flange 1208.

The OHT system 1200 of the present invention may also include a sensor 1210 coupled to the cradle 1204 that may be used to detect any kind of unanticipated rotational or twisting moments that arise when the cradle 1204 engages the flange 1208 and lifts the carrier 1206. The sensor 1210 may be operative to send a signal to a controller 1214 via, for example, a wireless protocol. The signal may indicate that a particular carrier 1206 is imbalanced. The signal may also indicate how much the carrier 1206 is out of balance. In some embodiments, the controller 1214 may signal a robot 1216 to move an effector 1218 to remove the imbalanced carrier 1206 from the band 1202.

In some embodiments, the carrier 1206 may include adjustable substrate supports 1220 that may be used to balance a carrier 1206 that has been removed from the band 1202. An effector 1218 may be used to set the adjustable substrate supports 1220 to balance the carrier 1206. In some embodiments, the effector 1218 may move the adjustable substrate supports 1220 based on the information transmitted to the controller 1214 by the sensor 1210.

Accordingly, while the present invention has been disclosed in connection with exemplary embodiments thereof, it should be understood that other embodiments may fall within the spirit and scope of the invention, as defined by the following claims.

1. An apparatus comprising:
a carrier having a center of gravity; and
one or more substrate supports disposed within the carrier to hold a substrate such that a center of gravity of the substrate is aligned with the center of gravity of the carrier.

2. The apparatus of claim 1 further including a counterweight coupled to the carrier and disposed such that the carrier's center of gravity is aligned with the center of gravity of a substrate storable in the carrier.

3. The apparatus of claim 1 wherein the carrier has a geometry such that the carrier's center of gravity is aligned with the center of gravity of a substrate storable in the carrier.

4. The apparatus of claim 1 wherein the carrier is constructed of materials having densities such that the carrier's center of gravity is aligned with the center of gravity of a substrate storable in the carrier.

5. The apparatus of claim 1 further including a flange coupled to the carrier and adapted to provide a net support force to the carrier that is aligned with the center of gravity of the carrier.

6. The apparatus of claim 5 wherein the flange includes a conical member for supporting the carrier by a human operator.

7. The apparatus of claim 6 wherein the conical member extends from the carrier and includes outwardly sloping sides.

8. The apparatus of claim 6 wherein the conical member is accessible via one or more cut-outs in the flange.

9. The apparatus of claim 5 wherein the flange includes a grip member for supporting the carrier by a human operator.

10. The apparatus of claim 9 wherein the grip member has a quarter bead shape.

11. An apparatus comprising:
a carrier having an empty center of gravity aligned with a full center of gravity; and
a flange coupled to the carrier and adapted to provide a net support force to the carrier that is aligned with the aligned empty and full center of gravities.

12. An apparatus comprising:
a carrier that has a constant center of gravity regardless of a number of substrates the carrier holds; and
a flange coupled to the carrier and adapted to provide a net support force to the carrier aligned with the center of gravity of the carrier.

13. An apparatus comprising:
a carrier; and
one or more substrate supports within the carrier,
wherein the carrier has a center of gravity independent of a number of substrates held by the substrate supports.

14. A method comprising:
balancing a carrier such that a center of gravity of the carrier is constant regardless of the number of substrates stored within the carrier; and
supporting the carrier using a force aligned with the center of gravity of the carrier.

15. The method of claim 14 further comprising:
accelerating the carrier by increasing the force without providing lateral support.

16. An apparatus comprising:
means for balancing a carrier such that a center of gravity of the carrier is constant regardless of the number of substrates stored within the carrier; and
means for supporting the carrier using a force aligned with the center of gravity of the carrier.

17. The apparatus of claim 16 wherein the means for balancing includes a counterweight applied to a first side of the carrier.

18. The apparatus of claim 15 wherein the means for balancing includes means for offsetting a mass of a door of the carrier.

19. An apparatus comprising:
a transport system adapted to move substrates stored in carriers; and
at least one carrier adapted to be transported by the transport system and to hold one or more substrates, the at least one carrier having a constant center of gravity regardless of a number of substrates held by the at least one carrier.

20. The apparatus of claim 19 wherein:
the at least one carrier includes a flange,
the transport system is adapted to lift the at least one carrier via a cradle coupled to the flange, and
the flange is adapted to apply a net lifting force to the at least one carrier that is aligned with the center of gravity of the at least one carrier.
